(19) United States
(12) Patent Application Publication
(10) Pub. No.: US 2023/0184486 A1
(43) Pub. Date: Jun. 15, 2023

(54) Refrigerating Device for a Recreational Vehicle

(71) Applicant: Dometic Sweden AB, Solna (SE)

(72) Inventors: Marcus Remmel, Roth (DE); Jörg Peter, Meinerzhagen (DE); Michael Steiger, Wenden (DE)

(21) Appl. No.: 18/163,043

(22) Filed: Feb. 1, 2023

Related U.S. Application Data
(63) Continuation of application No. 17/536,454, filed on Nov. 29, 2021, now Pat. No. 11,578,913.
Application No. 17/536,454 is a continuation of application No. 16/328,079, filed on Feb. 25, 2019, now Pat. No. 11,187,456.

(30) Foreign Application Priority Data
Aug. 26, 2016 (DE) 102016216126.1

(51) Int. Cl. F25D 29/00; F25D 23/12

(52) U.S. Cl. CPC F25D 29/005; F25D 23/12; F25D 31/005; F25D 2400/361

(57) ABSTRACT

The present invention is intended to provide a refrigerating device for a recreational vehicle, comprising a refrigerating chamber, which is defined by side walls, an upper wall and a lower wall and a front opening, the refrigerating device further comprising a door which is configured to allow sealing of the front opening and to allow accessing the refrigerating chamber via the front opening, an input panel comprising a display, an input knob and a processing unit. The display depicts a plurality of items which correspond to a plurality of executable input methods to be triggered by a user via actuation of the input knob.

### CLAIM TO PRIORITY

This continuation patent application claims priority to and benefit of, under 35 U.S.C. §120, U.S. Continuation Pat. Application with Serial No. 17/536,454, filed Nov. 29, 2021, which claims priority to U.S. 371 National Stage Pat. Application with Serial No. 16/328,079, filed Feb. 25, 2019, which claims priorty to PCT Patent Application with Serial Number PCT/EP2017/071052, filed Aug. 21, 2017, which claims priority to DE Patent Application with Serial Number 102016216126.1, filed Aug. 26, 2016, all of which is incorporated by reference herein.

### BACKGROUND

### 1. Field of the Invention

The present embodiments relate to a refrigerating device for a recreational vehicle and in particular to a refrigerator for a recreational vehicle.

### 2. Description of the Related Art

A recreational vehicle in the sense of the invention may be a caravan, a mobile home, a yacht or any other vehicle being equipable with a refrigerating device. Such refrigerating devices comprise a refrigerating chamber that is defined by side walls, an upper and a lower wall and a front opening. Such refrigerating devices further comprise a door, which is configured to allow sealing of the front opening and to allow accessing the refrigerating chamber via the front opening, an input panel comprising a display, an input knob and a processing unit.

Recreational vehicles in general have limited space available for built-in components like refrigerating devices. Furthermore, refrigerating devices for recreational vehicles may require a much increased user interaction compared to refrigerating devices for stationary applications. More specifically, mobile refrigerating devices may have the option of selecting a specific source of power, adjusting the refrigerating temperature in order to maintain energy efficiency and also turning the mobile refrigerating device on and off again, which is most likely occurring more frequently compared to stationary applications of refrigerating devices.

Therefore, it is generally desired to provide a user-friendly interface for a convenient operation of the refrigerating device. The object of this invention is therefore to provide all relevant inputs for controlling the refrigerating device in a convenient and small in dimension set-up which is user-friendly and easy to use and operate.

### SUMMARY

The object is achieved by means of a refrigerating device with the features of claim 1. Favorable developments are provided in the dependent claims.

One embodiment of the refrigerating device for a recreational vehicle comprises a refrigerating chamber which is defined by side walls, an upper and a lower wall and a front opening. The refrigerating device further comprises a door which is configured to allow sealing of the front opening and to allow accessing the refrigerating chamber via the front opening, an input panel comprising a display, an input knob and a processing unit, wherein the display depicts a plurality of items which correspond to a plurality of executable input methods to be treated by a user via actuation of the input knob.

The refrigerating device according to the present invention thus has a panel that allows triggering all relevant commands for operating the refrigerator via an input knob and by means of selecting depicted items on a display. Processing user inputs via the input knob as well as computing the display is achieved by a processing unit. The terms “executable input method” relates to a predetermined algorithm or computational method for controlling an arbitrary component of the refrigerating device.

In some embodiments, each item of the plurality of items depicted on the display corresponds to a specific executable input method selected from the list, including setting a refrigerating temperature, preparing crushed ice or ice cubes, setting the source of energy, defrosting the refrigerating chamber, setting an alarm, controlling ventilation of the refrigerating chamber and adjusting the volume or light. Obviously, the list of specific executable input methods as provided before is not restricted thereto and may include any other executable input method useful for operating a refrigerating device. In some embodiments, the item depicted on the display which corresponds to a specific executable input method is depicted in a manner that allows anticipation of the intended functionality by intuition. In view of the above, the user may quickly identify the desired executable input method and trigger the same via actuation of the input knob.

In some embodiments, the input panel is fixedly mounted to the housing of the refrigerating device. By means of such a fixed arrangement, damages of the input panel, caused for example by accidental slamming of the door against objects inside the recreational vehicle, is substantially reduced. In some embodiments, the input panel is integrated into the body of the refrigerating device such that it is integrated smoothly and substantially without gaps between the input panel and the refrigerating device.

In one embodiment, the refrigerating device comprises a first refrigerating chamber and a second refrigerating chamber, whereas the first refrigerating chamber is a freezer and the second refrigerating chamber is a refrigerator. Controlling the later combination of refrigerating chambers may be achieved either by controlling both chambers via one control panel or by controlling each chamber via an individual control panel. Alternatively, the refrigerating device may comprise a different further refrigerating chamber which is accommodated on the inside of the refrigerating device.

The term “refrigerating chamber” however is not limited thereto. According to the present embodiments, it is also possible to provide a chamber in addition to or as substitution for an already present refrigerating chamber. For instance, a combination of a refrigerating chamber with a cabinet, a microwave, an oven or the like into the refrigerating device is also possible to be controlled via the input panel. Accordingly thereto, one embodiment constitutes a combination of a refrigerating chamber with an oven. The refrigerating device of the present invention, thus, preferably comprises a further chamber, whereas the further chamber is an oven. The oven is also connected with and to be controlled via the input panel. With this preferred configuration, the present invention provides a one compact device for heating and cooling which is centrally controllable by one input panel. The plurality of items depicted by the display, thus, further correspond to a plurality of executable input methods for the oven to be triggered by a user via actuation of the input knob.

In some embodiments, the specific executable input methods concerning the oven include one or more methods selected from the list consisting of turning gas on and off, setting a heating temperature, setting a heating mode like, for example, top heat, bottom heat, circulating air, rotisserie grill and combinations thereof, various time settings like, for example, a starting time and a duration for the heating, setting an alarm, controlling ventilation of the oven chamber, setting light settings and adjusting the volume.

In at least one embodiment, the oven is the top chamber of the refrigerating device of the present invention. This is advantageous since air warmed from the oven rises to the top which would adversely affect the refrigerating chamber if it would be the other way round.

In some embodiments, the input panel placed above and/or below a door of a refrigerating chamber of a refrigerating device, such that the panel is substantially at the same height as an upper and/or a lower wall of a refrigerating chamber of the refrigerating device. Thus, the spaces above or below a door of a refrigerating chamber may effectively be consumed by the panel according to the embodiments. Advantageously, formerly dead space is now effectively used, thus the overall dimensions of the refrigerating device may be reduced. In one embodiment, the control panel is placed such that it is directly adjacent to a horizontal door of the refrigerating device.

In some embodiments, the processing unit operatively connects the display unit display knob such that triggering an input method is achieved by rotating the input knob to select at least one of the depicted items corresponding to the desired input method and by pressing the input knob to execute the desired input method corresponding to the selected depicted item. Here, triggering an input method requires two inputs, namely a) selecting of an item by means of rotating the knob and b) execution of the input method that corresponds to the selected item by pressing the input knob. This approach provides an easy to use, easy to understand and failure-safe triggering of a desired input method. The input knob therefore has two degrees of freedom, namely rotation about its access of rotation and lateral movement along its access of rotation. Naturally, further degrees of freedom might be introduced for selecting and/or executing input methods, for example tilting the knob about its access of rotation or laterally shifting the knob in parallel to its access of rotation. Furthermore, pressing the input knob may optionally also open a sub-menu which is depicted on the display after pressing the input knob. In general, rotating the input knob corresponds to swiping through menu items and pressing the knob corresponds to confirming or activating the currently selected item.

The door of the refrigerating device may be hinged at a left and/or right side of the refrigerating chamber and comprises at least one handle to access the refrigerating chamber. In a preferred embodiment, the handle is a vertical notch, protruding into the inside of the door of the refrigerating device. Preferably, the door of the refrigerating device may be open both to the left side and to the right side by means of suitable left and right hinge and locking mechanisms.

The panel may constitute an integral part of the refrigerating device. In the sense of the embodiments, the input panel of the refrigerating device incorporates further functionalities, such as providing parts of the housing structure, providing a supporting structure or constituting a part of the frame of the refrigerating device. It is advantageous, to integrate the input panel such that it is easily to be connected with the devices to be controlled via the input panel.

The input panel forms a substantially even surface and the input knob is the only protruding component on the input panel. In the sense of the embodiments, the presence of gaps, protrusions or recesses shall be reduced to a minimum, in order to reduce the chance of dirt, dust or food remains accumulating on the input panel. By doing so, cleaning of the outside surfaces of the refrigerating device may easily be achieved. Also, during times without constantly maintained cleaning procedures, for example during times when the recreational vehicle is not used, accumulation or growth of potentially harmful substances or biologic material on the input panel is minimized. Therefore, no other protrusion except for the protruding input knob shall be present. The display of the input panel is covered by a transparent section of an input panel cover, in order to achieve an even surface with respect to the input panel and the adjacent components of the refrigerating device.

The input knob may be the only controlling device on the input panel. In the sense of the invention, the user inputs for controlling the refrigerating device shall only be provided via the input knob, in order to reduce the complexity of production, assembly and maintenance of the input panel. Also, the user interaction is much more intuitive, hence fail safe, if only one input knob is present.

### BRIEF DESCRIPTION OF THE DRAWINGS

The invention will now be described in more detail with reference to the figures showing a preferable embodiment, wherein:

FIG. 1 is a prospective view of the refrigerating device according to a fist embodiment of the invention comprising a first refrigerating chamber and a second refrigerating chamber;

FIG. 2 is a prospective view of an isolated input panel according to the invention;

FIG. 3 is a front view of an isolated input panel according to the invention;

FIG. 4 is section of a refrigerating device according to a first embodiment of the invention in a front view showing the input panel;

FIG. 5 is an exploded view of the input panel according to the invention;

FIG. 6 is a prospective sectional view of a refrigerating device according to a first embodiment of the invention; and

FIG. 7 is a front view showing several embodiments of a refrigerating device 1 for a recreational vehicle.

### DETAILED DESCRIPTION

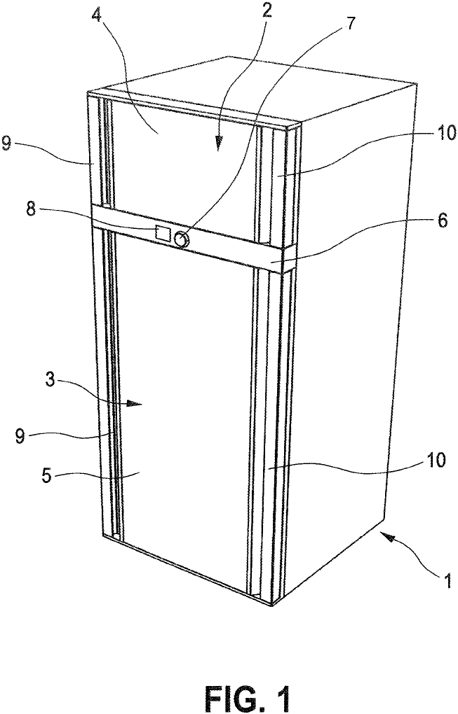

In this particular embodiment of FIG. 1 the refrigerating device 1 comprises a first refrigerating chamber 2, e.g. a freezing compartment, and a second refrigerating chamber 3, e.g. a cooling compartment. Accordingly, the first refrigerating chamber has a first door 4 and a second refrigerating chamber 3 has a second door 5. In between the first door 4 and the second door 5 on the front side of the refrigerating device 1 is provided an input panel 6 with an input knob 7 and a display 8. Each of the first door 4 and the second door 5 comprises a left handle 9 and a right handle 10 for individually and selectively opening the first door 4 and/ or the second door 5 to either the left or the right side. Thereby, the input panel 6 remains stationary attached to the refrigerating device 1. The input panel is further shaped such that it follows the encompassing surface of the refrigerating device without forming protrusions or recesses. The input panel 6 is further provided in a height that corresponds with the lower wall of the first refrigerating chamber 2 and the upper wall of the second refrigerating chamber 3 in order to make use of the dead space in between the first refrigerating chamber 2 and the second refrigerating chamber 3.

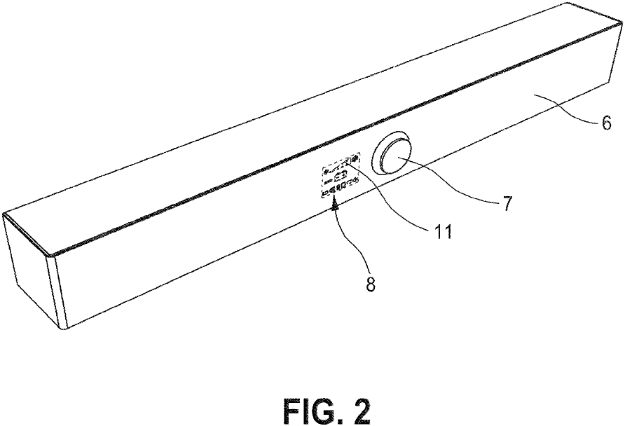

In FIG. 2, the input panel is shown in more detail. It is shown that the input knob has a circular shape and is provided on the right side next to a rectangular display 8 showing a plurality of items 11 which correspond to specific executable input methods and operating modes that may be selected by rotating the input knob 7 and which may be executed by pressing the input knob 7 when the desired item 11 is selected.

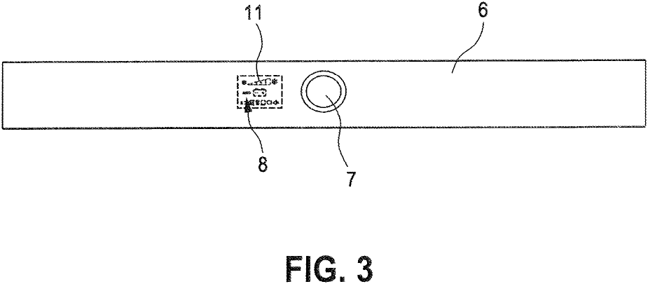

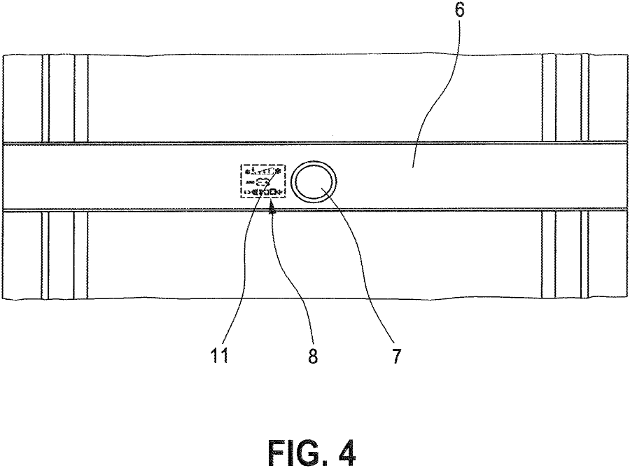

FIG. 3 shows a front view of the isolated input panel 6 and FIG. 4 the input panel 6 as shown in FIG. 3 in combination with the refrigerating device 1. Here it is shown a plurality of items 11 consisting of symbols representing temperature, battery, power source, defrosting, volume control, ventilation and the like.

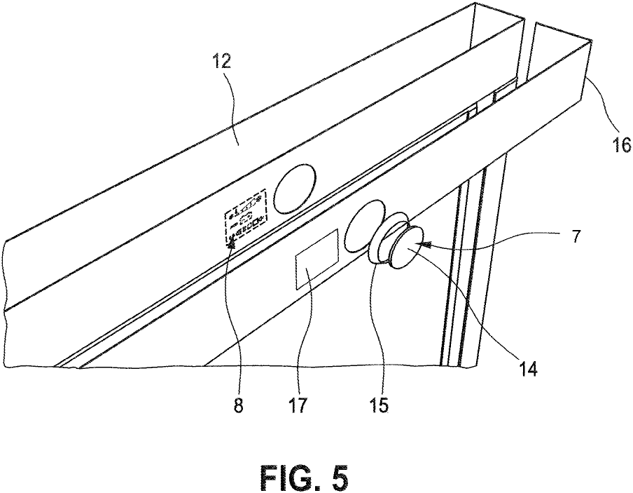

The individual components of the input panel 6 are further shown in FIG. 5. The input panel 6 mainly consists of an input panel core 12, housing the processing unit (not shown), and the display 8, the input knob 7, consisting of a circumferential plate 14 and a ring 15 as well as a cover panel 16. The ring 15 is placed in between the cover panel 16 and the circumferential plate 14. The input panel 6 further comprises a transparent section 17 which aligns with the display 8 that is provided in the input panel core 12 in position and dimension. Thus, the display 8 may conveniently be observed in a mounted condition of the input panel 6, whilst being protected through the cover panel 16.

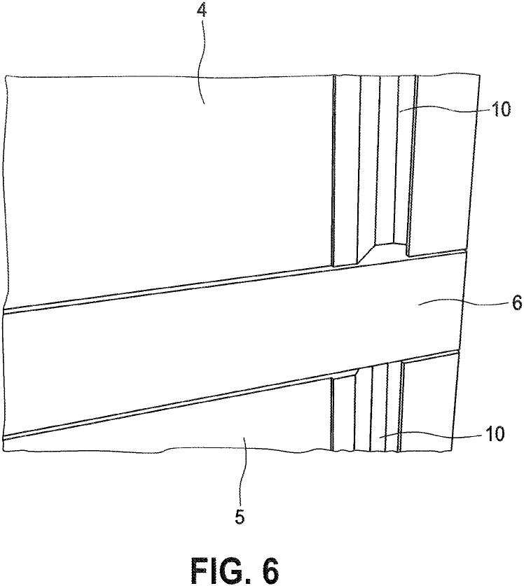

FIG. 6 shows a prospective sectional view of a refrigerating device 1 according to a first embodiment of the invention. It can be seen that the input panel 6 is located adjacent to the first door 4 of the first refrigerating chamber 2 and the second door 5 of the second refrigerating chamber 3. Furthermore, each of the first door 4 of the first refrigerating chamber 2 and the second door 5 of the second refrigerating chamber 3 have vertical left and right handles 9, 10 to open the doors 4, 5 individually and selectively either to the right side or to the left side.

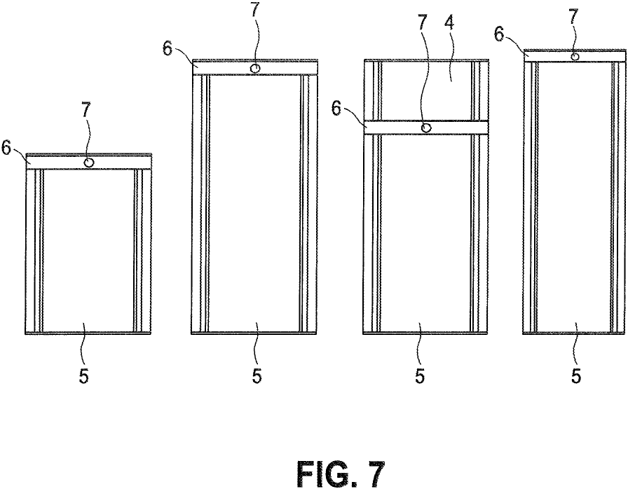

FIG. 7 depicts a variety of further embodiments of a refrigerating device 1 according to the invention. Accordingly, the refrigerating device 1 may either have only one refrigerating chamber, or a first refrigerating chamber 2 and a second refrigerating chamber 3. In either embodiment, the input panel 6 is fixedly provided on the front of the refrigerating device 1 above and/or below a door of the refrigerating chamber of the refrigerating device. The latter is specifically useful, since normally, this dead space would be covered by the doors or an additional blind. Here, the usually unused space is turned into a conveniently reachable space for housing the input panel 6.

1. A refrigerating device, comprising:
a housing having an upper wall, a lower wall, a first sidewall, and a parallel second sidewall;
a first chamber defined within said housing and a second chamber defined within said housing, said first chamber and said second chamber being separated and defining a space therebetween;
a first door covering the first chamber and a second door covering the second chamber, wherein each of said first door and said second door may be pivotally opened to access said first chamber and said second chamber, respectively;
an input panel extending horizontally in said space between said first door and said second door, said input panel having a display and an input knob thereon, wherein said display depicts a plurality of items which correspond to a plurality of executable input methods to be triggered by a user via rotation and pressing of the input knob.

2. The refrigerating device of claim 1, one of said first chamber or said second chamber comprising a refrigerator.

3. The refrigerating device of claim 2, the other of said first chamber or said second chamber comprising a freezer.

4. The refrigerating device of claim 1, wherein one of said first chamber or said second chamber comprises an oven.

5. The refrigerating device of claim 1, wherein the input panel further comprises a cover panel with a transparent section.

6. The refrigerating device of claim 5, wherein said display is aligned with said transparent section.

7. The refrigerating device of claim 1, wherein each item of the plurality of items depicted on the display corresponds to a specific executable input method selected from a list, including one of or a plurality of setting a refrigeration temperature, preparing crushed ice or ice cubes, setting a source of energy, defrosting the first chamber or the second chamber, setting an alarm, controlling ventilation of the first or the second chamber, setting light settings or adjusting audible volume.

8. A refrigerating device, comprising:
a housing having an upper wall, a lower wall, a first sidewall, and a parallel second sidewall;
a chamber defined within said housing;
a door pivotally connected to said housing and covering an opening into said chamber;
an input panel extending horizontally across said upper wall of the housing, above an upper edge of said door;
said input panel having a display and an input knob thereon, wherein said display depicts a plurality of items which correspond to a plurality of executable input methods to be triggered by a user via rotation and pressing of the input knob.

9. The refrigerating device of claim 8, said chamber defining one of a refrigerator or a freezer.

10. The refrigerating device of claim 8, wherein each item of the plurality of items depicted on the display corresponds to a specific executable input method selected from a list, including one of or a plurality of setting a refrigeration temperature, preparing crushed ice or ice cubes, setting a source of energy, defrosting the chamber, setting an alarm, controlling ventilation of the chamber, setting light settings or adjusting audible volume.

11. The refrigerating device of claim 8, wherein the input panel further comprises a cover panel with a transparent section and is aligned with said display.

12. The refrigerating device of claim 11, further comprising the display being operably connected with the input knob such that triggering an input method is achieved by said rotation the input knob to select at least one of the depicted items corresponding to the input method and by said pressing the input knob to execute the desired input method corresponding to the selected depicted item.

13. The refrigerating device of claim 10, further comprising a second chamber, wherein said chamber define two of a refrigerator, a freezer, or an oven.

14. A refrigerating device, comprising:
a housing having an upper wall, a lower wall, a first sidewall, and a parallel second sidewall;
a first chamber defined within said housing and a second chamber disposed within said housing and separated from said first chamber;
a first door pivotally connected to said housing to access said first chamber, and a second door pivotally connected to said housing to access said second chamber, said first door disposed above said second door;
said first and second doors each having handles adjacent to edges of said doors and being symmetrically arranged to allow opening in both a right hand direction and a left hand direction.
